(19) United States
(12) Patent Application Publication
(10) Pub. No.: US 2019/0261433 A1
(43) Pub. Date: Aug. 22, 2019

(54) SOFTWARE ARCHITECTURE FOR IOT DEVICE COLLECTOR

(71) Applicants: William Jason Turner, Leander, TX (US); John A. Fortkort, Austin, TX (US); Stefan Krassin, Freiburg (DE)

(72) Inventors: William Jason Turner, Leander, TX (US); John A. Fortkort, Austin, TX (US); Stefan Krassin, Freiburg (DE)

(21) Appl. No.: 16/166,065

(22) Filed: Oct. 19, 2018

Related U.S. Application Data
(63) Continuation-in-part of application No. 16/016,543, filed on Jun. 22, 2018.
(60) Provisional application No. 62/523,371, filed on Jun. 22, 2017.
(60) Provisional application No. 62/523,383, filed on Jun. 22, 2017.
(60) Provisional application No. 62/523,397, filed on Jun. 22, 2017.
(60) Provisional application No. 62/574,217, filed on Oct. 19, 2017.

(51) Int. Cl. H04W 76/10; H04L 29/08; H04L 12/28

(52) U.S. Cl. CPC H04W 76/10; H04W 84/18; H04L 12/2803; H04L 67/10

(57) ABSTRACT

A network is provided which includes a plurality of RF nodes; a plurality of RF collectors, each of which is equipped with a tangible, computer readable storage medium; and a software suite, an instance of which is installed on the storage medium associated with each of said plurality of RF collectors. The software suite includes a network layer for establishing a mobile ad-hoc mesh network; an operating system; a routing protocol; a virtual network; a distributed database; a set of drivers; a set of RF software handlers; a set of user applications; and a dashboard.

### CROSS-REFERENCE TO RELATED APPLICATIONS

This application is a continuation-in-part of U.S. Ser. No. 16/016,543 (Turner et al.), entitled “SOFTWARE ARCHITECTURE FOR IOT DEVICE COLLECTOR”, which was filed on Jun. 22, 2018, and which is incorporated herein by reference in its entirety, which claims priority from U.S. Provisional Application No. 62/523,371, entitled “RF NETWORK EQUIPPED WITH AN IOT DEVICE COLLECTOR AND A CLIENT WHICH IMPLEMENTS BLOCKCHAINING AND A HYPER DISTRIBUTION COMMUNICATIONS PROTOCOL”, which was filed on Jun. 22, 2017, and which is incorporated herein by reference in its entirety. This application also claims priority from U.S. Provisional Application No. 62/523,383, entitled “RF CLIENT FOR IMPLEMENTING A HYPER DISTRIBUTION COMMUNICATIONS PROTOCOL AND MAINTAINING A DECENTRALIZED, DISTRIBUTED DATABASE AMONG RADIO NODES”, which was filed on Jun. 22, 2017, and which is incorporated herein by reference in its entirety. This application also claims priority from U.S. Provisional Application No. 62/523,397, entitled “IOT DEVICE COLLECTOR AND NORMALIZATION ENGINE”, which was filed on Jun. 22, 2017, and which is incorporated herein by reference in its entirety. This application also claims priority from U.S. Provisional Application No. 62/574,217, entitled “SOFTWARE ARCHITECTURE FOR IOT DEVICE COLLECTOR”, which was filed on Oct. 19, 2017, and which is incorporated herein by reference in its entirety.

### TECHNICAL FIELD OF THE INVENTION

The present invention pertains generally to networks of RF nodes, and more particularly to an RF client which establishes a hyper distribution communications protocol among RF nodes and maintains a decentralized, distributed database of transactions between the RF nodes.

### BACKGROUND OF THE INVENTION

Various devices are known to the art which utilize radio frequency (RF) signals for the purposes of communication. Various technologies and protocols have also been developed in the art to allow such RF devices to communicate. At present, each of these technologies and protocols is directed to a specific use case or type of RF device.

For example, Z-Wave is a wireless communications protocol that is oriented to the residential control and automation market, and is intended to provide a simple and reliable method to wirelessly control lighting, HVAC, security systems, home cinema, automated window treatments, swimming pool and spa controls, and garage and home access controls. Like other protocols and systems aimed at the home and office automation market, a Z-Wave automation system can be controlled via the Internet, with a gateway or central control device serving as both the hub controller and portal to the outside.

Zigbee is an IEEE 802.15.4-based specification for a suite of high-level communication protocols developed to create personal area networks with small, low-power digital radios. The Zigbee specification is used in applications such as home automation, medical device data collection, and other low-power, low-bandwidth needs. Zigbee is designed for small scale projects which require wireless connection. Accordingly, Zigbee is a specification for low-power, low data rate, and close proximity (i.e., personal area) wireless ad hoc networks.

Bluetooth is a wireless technology standard for exchanging data over short distances from fixed and mobile devices, and for building personal area networks (PANs). This technology uses short-wavelength UHF radio waves in the ISM band from 2.4 to 2.485 GHz.

IEEE 802.11 is a set of media access control (MAC) and physical layer (PHY) specifications for implementing wireless local area network (WLAN) communications in the 900 MHz and 2.4, 3.6, 5, and 60 GHz frequency bands. These specifications provide the basis for wireless network products which use the Wi-Fi brand.

Radio-frequency identification (RFID) is a technology which uses electromagnetic fields to automatically identify and track tags attached to objects. The tags contain electronically stored information, and may be active or passive devices. Active tags have a local power source, such as a battery, and may operate at hundreds of meters from the RFID reader, while passive tags rely on collecting energy from an RFID reader's interrogating radio waves, and hence require proximity to the reader. RFID tags are advantageous over barcodes in that the tag does not need to be within the line of sight of the reader, and hence may be embedded in the tracked object.

RFID is one method for implementing Automatic Identification and Data Capture (AIDC). RFID tags are used in many industries. For example, an RFID tag may be attached to an automobile during production and used to track the progress of the automobile through the assembly line. RFID-tagged pharmaceuticals may be tracked through warehouses. RFID microchips may be implanted in livestock and pets to allow for the positive identification of these animals.

Near-field communication (NFC) is a set of communication protocols that enable two electronic devices (one of which is usually a portable device such as a smartphone) to establish communication by bringing them within 4 cm (1.6 in) of each other. NFC offers a low-speed connection with simple setup that can be used to bootstrap more capable wireless connections. NFC devices are commonly used in contactless payment systems, similar to those used in credit cards and electronic ticket smartcards, and allow mobile payment to replace or supplement these systems. NFC-enabled devices may also act as electronic identity documents and keycards. NFC is also commonly used for social networking, and for sharing contacts, photos, videos and files.

### SUMMARY OF THE INVENTION

In one aspect, a system is provided which comprises (a) a plurality of RF devices, wherein each RF device contains a tangible, non-transient memory device; and (b) a software client, an instance of which is recorded in the memory device of each of said plurality of RF devices; wherein said software client contains suitable programming instructions which, when implemented by at least one processor of at least one computational device, implements a hyper distribution communications protocol among the RF devices and maintains a decentralized and distributed database of transactions between the RF devices.

In another aspect, a method is provided for establishing a network among a plurality of RF devices. The method comprises (a) implementing a hyper distribution communications protocol among the RF devices; and (b) maintaining a decentralized and distributed database of transactions between the RF devices.

In a further aspect, a system is provided which comprises (a) a plurality of RF devices, wherein each RF device contains a tangible, non-transient memory device; and (b) a software client, an instance of which is recorded in the memory device of each of said plurality of RF devices; wherein said software client contains suitable programming instructions which, when implemented by at least one processor of at least one computational device, implements a hyper distribution communications protocol among the RF devices and maintains a decentralized and distributed database of transactions between the RF devices.

In another aspect, a method for establishing a network among a plurality of RF devices is provided. The method comprises (a) implementing a hyper distribution communications protocol among the RF devices; and (b) maintaining a decentralized and distributed database of transactions between the RF devices.

In yet another aspect, a network is provided which comprises (a)m a plurality of radio nodes which are in RF communication with each other, wherein said plurality of radio nodes includes first and second radio nodes that communicate via first and second distinct RF protocols or RF technologies; and (b) an RF collector which aggregates the RF communications from the plurality of radio nodes and normalizes those RF communications into a singular output format.

In a further aspect, a method for establishing a communications network among a plurality of radio nodes is provided. The method comprises (a) organizing the plurality of radio nodes into a network in which each of said radio nodes are in RF communication with each other, wherein said plurality of radio nodes includes first and second radio nodes that communicate via first and second distinct RF protocols or RF technologies; (b) aggregating the spectrum of RF communications from the plurality of radio nodes; and (c) normalizing the aggregated RF communications into a singular output format.

In another aspect, a network is provided which comprises (a) a plurality of radio nodes which are in communication with each other and which are organized in a mesh topology, wherein said plurality of radio nodes are selected from a spectrum of RF devices; (b) an RF collector which aggregates a spectrum of RF communications from the plurality of radio nodes and normalizes those RF communications into a singular output format; and (c) an RF client, an instance of which is associated with each radio node, wherein said RF client implements a hyper distribution communications protocol among the nodes, and wherein said client maintains a decentralized and distributed database of transactions between the radio nodes.

In another aspect, a method is provided for establishing network. The method comprises (a) organizing a plurality of radio nodes into a network having a mesh topology in which each of said radio nodes are in communication with each other, wherein said plurality of radio nodes are selected from a spectrum of RF devices; (b) implementing a hyper distribution communications protocol among the radio nodes such that each radio node in the plurality of radio nodes maintains a decentralized and distributed database of transactions between the radio nodes; (c) aggregating the spectrum of RF communications from the plurality of radio nodes; and (d) normalizing the aggregated RF communications into a singular output format.

In a further aspect, a network is provided which includes a plurality of RF nodes; a plurality of RF collectors, each of which is equipped with a tangible, computer readable storage medium; and a software suite, an instance of which is installed on the storage medium associated with each of said plurality of RF collectors. The software suite includes a network layer for establishing a mobile ad-hoc mesh network; an operating system; a routing protocol; a virtual network; a distributed database; a set of drivers; a set of RF software handlers; a set of user applications; and a dashboard.

### BRIEF DESCRIPTION OF THE DRAWINGS

For a more complete understanding of the present invention and the advantages thereof, reference is now made to the following description taken in conjunction with the accompanying drawings in which like reference numerals indicate like features.

FIG. 1 is an illustration of an embodiment of an IoT collector in accordance with the teachings herein.

FIG. 2 is an illustration of a system featuring an RF collector in accordance with the systems herein.

FIG. 3 is an illustration of an embodiment of a software client which implements a hyper distribution communications protocol and distributed transaction database for use in conjunction with the IoT collector of FIG. 1.

FIG. 4 is a block diagram of the software architecture of an embodiment of an ad hoc RF collector-based mesh network.

FIGS. 5-13 are screenshots of a software program for providing visualizing, monitoring and maintaining an ad hoc RF collector-based mesh network of the type disclosed herein.

### DETAILED DESCRIPTION OF THE INVENTION

With the advent of the Internet of Things (IoT), various items have been embedded with electronics, software, sensors, actuators, and network connectivity to enable these objects to collect and exchange data. However, despite the development of a large variety of such devices, at present, the collection and exchange of data tends to occur within discrete silos.

For example, at present, no standard communications protocols exist for the light switches in a house to talk to each other. While some instances of bridge software and communications protocols have been developed for devices of this type, at present, these software programs and communications protocols have been specific to particular devices and use cases. For example, in a home, there may be many different systems, such as temperature, lights, garage doors, locks, HVHD, and audio systems. Each of these systems is equipped with separate applications and communicates via separate RF principles and separate controllers. This problem is further exacerbated in the commercial spectrum.

This situation is at least partially a result of the disparate technologies and protocols that have been developed to enable these devices to collect and exchange data. In particular, at present, no standard communications vehicle exists between such devices and their master (the latter of which may be, for example, a user interface, a collection agent, an upstream router, or the like). For example, although home standards (such as Zigbee and Z-wave), business standards (such as RFID and 802.11), and international standards (such as Bluetooth and NFC) have all been developed, to date, no solution has been produced which aggregates a spectrum of disparate RF communications and normalizes them into a singular output format.

The foregoing problem is two-fold, in that no standards exist for either the IoT or for IoT communications. It will thus be appreciated that the plethora of RF devices developed in the art, and the variety of RF technologies and protocols that have been developed to allow these devices to communicate, has created an impediment to implementation of the Internet of Things (IoT).

It has now been found that some or all of the foregoing issue may be addressed with the systems and methodologies disclosed herein. In a preferred embodiment, these systems and methodologies comprise an RF collector which aggregates a spectrum of RF communications from a spectrum of RF devices or RF nodes, and which normalizes the RF communications into a singular output. The RF collector accomplishes this through the use of an RF client, instances of which are associated with each RF device. The RF client implements a protocol which facilitates communication among the RF devices. The communication protocol preferably leverages principles of blockchaining and hyper distribution communications protocols (such as, for example, bit torrent) to provide a highly secure network of radio nodes that are organized in a mesh topology. The RF client preferably implements this protocol to provide always-on, one-to-many communications among the radio nodes that can leverage full streaming network concepts such as 5G.

It will be appreciated from the foregoing that the devices and methodologies disclosed herein effectively provide a network which comprises (a) a plurality of radio nodes (which may be selected from a wide spectrum of RF devices) which are in communication with each other and which are organized in a mesh topology; (b) an RF collector which aggregates a spectrum of RF communications from the plurality of radio nodes and normalizes those RF communications into a singular output format; and (c) an RF client, an instance of which is associated with each radio node, wherein the RF client implements a hyper distribution communications protocol among the nodes, and wherein the client maintains a decentralized and distributed database of transactions between the radio nodes.

The systems and methodologies disclosed herein may be further appreciated with respect to the use case of a shipping port. Such a port may receive a cargo container from overseas that may have multiple types of cargo in it (i.e., it may be a mixed-mode cargo container). For example, the cargo container may contain an automobile for an individual, some electronic appliances from a large electronics company, and toys from a toy manufacturer.

The individual shipping the car is not likely to be a repeat shipper, and may not be well versed in the process involved. In present practice, the individual (or the individual's representative) will typically go to the shipping office and fill out papers that are placed in a plastic envelope. These papers essentially form the manifest for the automobile. Customs agents will review the manifest, levy taxes, and perform other such actions based on the manifest. At some point, it will typically be necessary for someone to manually enter all of the data into the manifest. This data may include the serial numbers, tracking numbers, warrants, customs, and other details required to get the automobile into the country in which the port is located.

The large electrical appliance company has likely been shipping appliances for years, and is accordingly likely to be well-versed in all of the shipping systems and ports. This company may have a digital manifest with one or more RFIDs in the containers of its products.

The toys being shipped by the toy company may be in corrugated cardboard containers with printed barcodes on them. In current practice, it is typically necessary to scan these barcodes with a portable device.

In this example, there are three different input mediums with the same output medium (i.e., a shipping manifest, which is likely a standard manifest that shipping companies and shipping yards use). Since shipping yards improve their profitability and competitive edge by processing more containers than competing yards, they are always competing with each other to provide more capacity and speed. Hence, the use of collectors of the type disclosed herein provide a competitive advantage for such business entities.

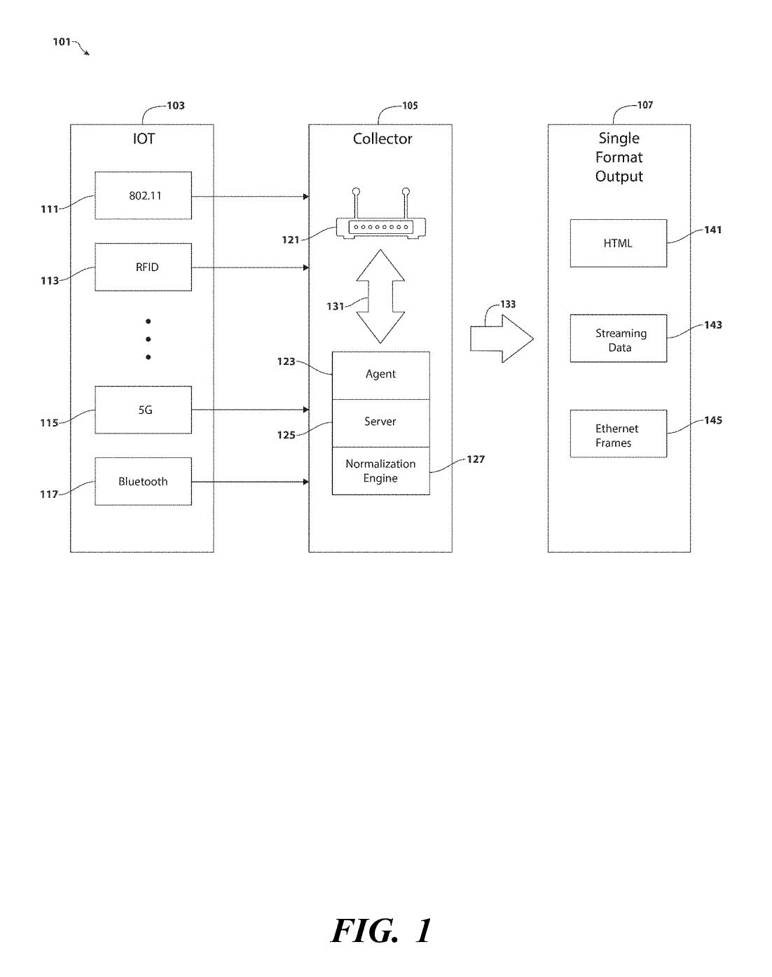

FIG. 1 illustrates a first particular, non-limiting embodiment of a system architecture 101 featuring a collector 105 in accordance with the teachings herein. In essence, in its preferred embodiment, the collector 105 is a device with many different inputs 103 and a singular output format 107. The inputs 103 may include, for example, 802.11 (Wi-Fi) 111, RFID 113, 5G radio 115 and Bluetooth 117. Each of these inputs 103 may require a different antenna. The collector 105 is preferably equipped with an agent 123 and a normalization engine 127, and works in conjunction with one or more servers 125. The singular output format 107 may be, for example, HTML 141, streaming data 143 or Ethernet frames 145.

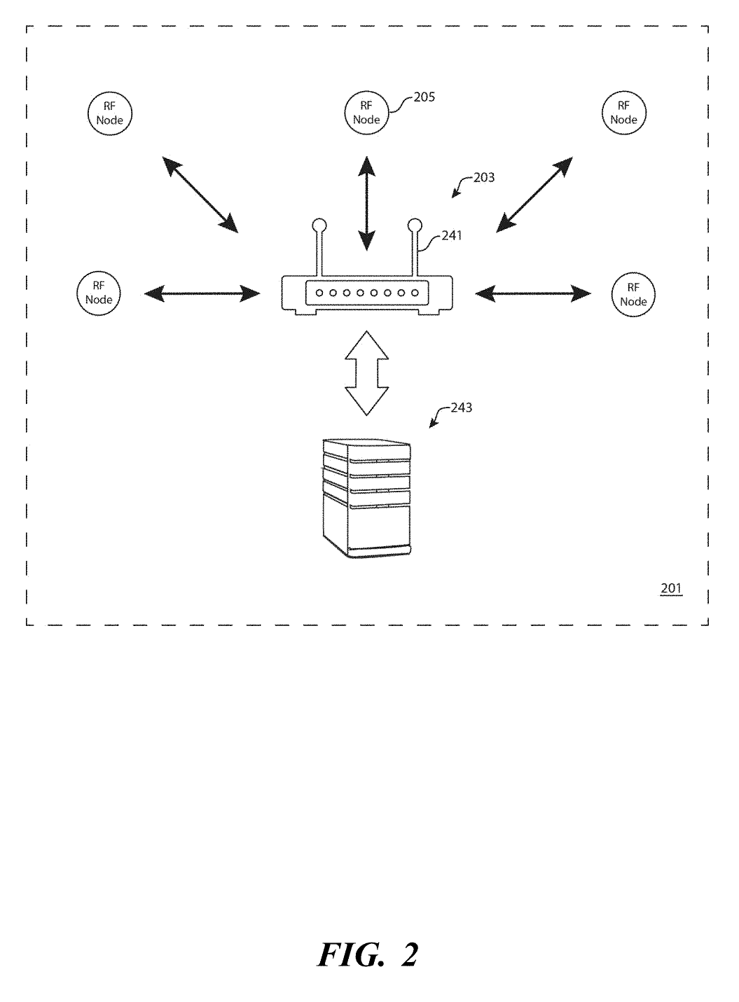

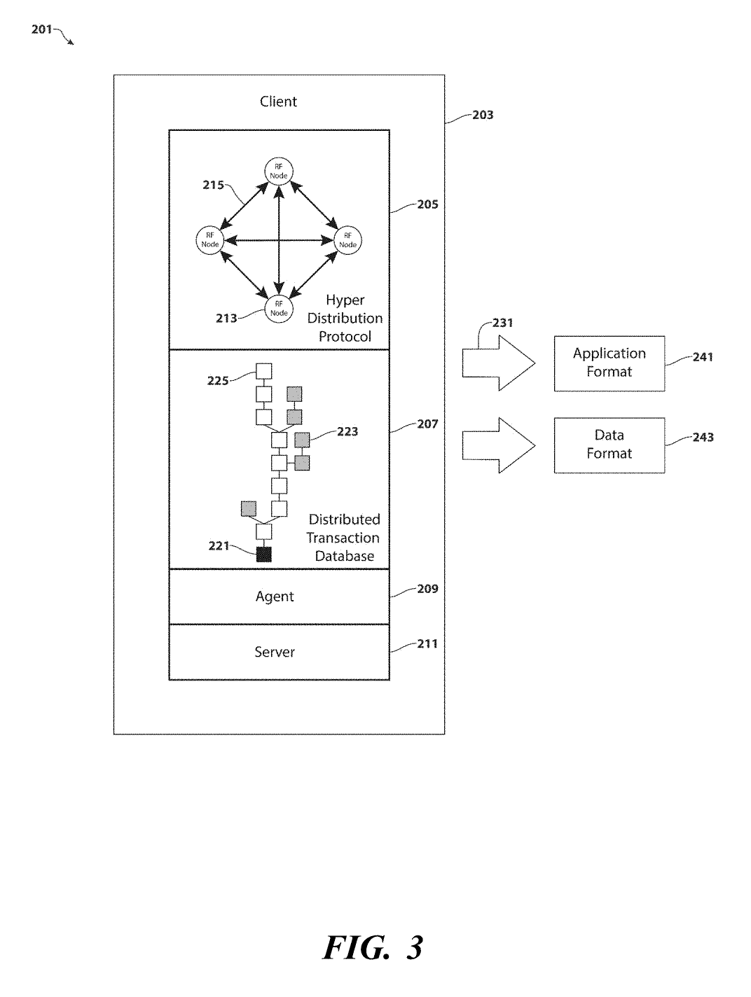

FIG. 2 depicts a particular, non-limiting embodiment of a system in accordance with the teachings herein. The system 201 includes a collector 203 equipped with a set of antennas 241 that receive known, configured input from various RF nodes 205 or RF devices and that work in conjunction with one or more servers 243 to take suitable action. This is preferably accomplished through the use of the client 301 depicted in FIG. 3.

For example, if the RF node 205 that the collector 203 is receiving RF input from is a phone, the collector 203 may implement a handshake, obtain a virtual subnet ID (VSID) and/or service set identifier (SSID), negotiate the conversation, establish a pairing relationship with the phone, and begin to receive Internet traffic. If the RF node 205 that the collector 203 is receiving RF input from is an RFID device, the collector 203 may establish a connection, scan the device, receive data packets from the device, and then decode the required data. If the RF node 205 that the collector 203 is receiving RF input from is a Bluetooth device, the collector 203 may excite or turn off the RF device if it is proximal to the collector 203, offer to pair, or take other suitable actions.

The one or more servers 243 associated with the collector 203 then receive the foregoing traffic and process it accordingly. In the case of traffic involving a Bluetooth device, the one or more servers 243 may establish communication and ask for a data stream. In the case of traffic involving an RFID device, the one or more servers 243 may operate in receive-only mode, receive the data, normalize it, and send it out. In the case of traffic involving an 802.11 device, the one or more servers 243 may provide encryption keys, software and call set-up.

Notably, some of the formats associated with RF devices are data formats, while others are transit formats. For example, RFID and Bluetooth are data formats, while ethernet (the only format 802.11 hosts) and 5G are transit formats. Hence, instead of sending an ethernet frame, the collector may normalize that output to a single format, which may vary from one use case to another.

As a particular, non-limiting example of the foregoing principles, the RF device may be smart luggage with an HTML output. It may be desirable to display the state of the luggage on a terminal (e.g., in the baggage claim area of an airport). For example, the owner of the luggage may wish to be notified when the luggage is expected to arrive at baggage claim, if it is still enroute, if it is still on the plane, or if it never left the departure city. This information may be part of the HTML output, which may be normalized and displayed on the display.

As another particular, non-limiting example of the foregoing principles, a plastic bracelet may be assigned to a patient when they check into an emergency room. The bracelet may be equipped with an RFID sensor to allow it to sense where the associated patient is in queue, and may display that information on an HTML board with appropriate messages (e.g., please return to the lobby).

As a further particular, non-limiting example of the foregoing principles, museums may be equipped with RF translation devices which operate in proximity to various targets disposed throughout the museum.

In each of the foregoing use cases, it may be desirable to receive the output of the RF input and display it in an online, real-time web type of capacity.

The systems, devices and methodologies disclosed herein may also be utilized in conjunction with streaming data. For example, it may be desirable to terminate an 802.11 from a camera and pass it to a DVR application running on a server. From there, it may be sent out as a stream of data to be recorded to a hard disk (e.g., for posterity).

Another use case for streaming data exists with respect to collecting beacons. In one particular, non-limiting embodiment of a use case involving the deployment of beacons, the beacon acts as an RF antenna which announces its presence, and a mobile device acknowledges the announcement. There is typically no more conversation, set-up or data. Hence, this use of beaconing may involve a type of streaming data.

For example, it may be desirable shortly after a game at a stadium to have the streetlights outside of the stadium turn red more frequently so pedestrians can cross the street. It may also be desirable at that time to increase police presence or arrange for emergency medical team standby. Streaming data may be utilized to make these decisions by determining where the crowd is going, as well as its ebb and flow. In such a case, the stream may be ignored until such time as it is desirable to take action based on it.

A further use case involves ethernet frames. In this application, the collector may be utilized as a normal axis point, and a mobile phone or mobile device may connect to the collector to access the Internet.

Use cases also exist which involve manual input. In such cases, someone could connect to the collector and perform data entry or OCR of documents (e.g., a shipping manifest) into an HTML page.

Various business models may be applied to the foregoing use cases. These may include, for example, consulting services around the creation of the output and the normalization and its customization to what a business wants. For example, in shipping yard applications, a party may charge a first fee for installing the collectors, and a second fee to write a manifest normalization engine.

Various applications also exist in which the interested parties have businesses centered around the manufacture of devices for telecommunications companies and municipalities. For example, a company manufacturing streetlights could install a collector of the type disclosed herein in their product. In such an application, installation of the collector on streetlights could occur on an existing install basis with an existing product, thus obviating the need to remove infrastructure to add new or enhanced capabilities. The new or enhanced capabilities could then be sold back to another party (such as, for example, a telecommunications company), could be provided by a governmental entity as a benefit to its citizens, or could be used to attract new businesses (e.g., it could allow a municipality to better compete for conventions and tourism). This approach could also be used in some applications (such as, for example, parking lots, stadiums, private streets, telecommunications areas or government areas) where entities desire exclusive control over these capabilities and want to keep the axis point for themselves.

The collector may also be utilized in healthcare facilities such as hospitals, nursing homes and emergency care centers. A typical healthcare facility is equipped with various medical devices (such as, for example, blood pressure monitors, heart rate monitors, blood oxygen levels, thermometers, and aspiration devices) which may be manufactured by different companies, and which may not communicate with each other, even though they may be equipped with wireless communication capabilities. Moreover, concerns exist about isolating one patient's readings from those of another (the protocol, discussed below, talks about the security aspects of this). Consequently, despite the wireless communications capabilities of these devices, it is common for healthcare facilities to have medical staff manually read the data from these devices.

The systems and methodologies described herein may be utilized to collect input from the various medical devices and create a singular output that describes a particular patient (and all of the inputs and outputs associated with that patient) as a piece of streaming data. This data may be provided to appropriate healthcare personnel. For example, a treating physician may utilize the data to make a diagnosis or prescribe medications. This data stream can also be utilized to generate an alert if, for example, it is in communication with some AI system or some business analytics system and it recognizes the signature or thumbprint of a medical event (such as, for example, the onset of a heart attack or stroke). Although there may be instances of this type of procedure being implemented on a singular device, such devices do not operate in a holistic capacity, due to the lack of a means by which the different devices can communicate. It will thus be appreciated that the collectors described herein may be utilized as a type of “healthbus” for these different protocols, thus allowing these different devices to communicate with each other.

In the 5G arena, it is likely that some parties will desire legacy connectivity. The collectors described herein may be utilized to provide a migration path from old to new. In such cases, the collectors described herein may be fabricated from commercial, off-the-shelf components, but will require the agent, the server and the normalization engine. These may be advantageously written in the language Go, since it is a cross-platform compiled language that may be written for any stack. The use of Go also provides for ready migration, because all of the binaries and libraries that make the application unique are encapsulated in one single file (this allows the application to be moved to any desired platform, and also allows the application to cross-compile immediately). Moreover, since Go is based off of a series of open source standards, it is not necessary to create constructs such as a network stack, a UI stack or an API call from scratch. Instead, it is typically only necessary to add the logic of what the application is doing. The agent will preferably be equipped with a TSR (Terminate and Stay Resident) application that will function as a daemon that runs all the time and listens for items of interest to the application. The server may be invoked by the agent or by a user's input to process something in an IFTT (If This Then That) type of capacity.

The normalization engine preferably runs as part of the agent and sends normalized data out, either in real-time or sequentially. These may be compiled services that may be run (in Go) in containers as microservices.

FIG. 3 depicts a particular, non-limiting embodiment of an RF client 301 in accordance with the teachings herein. With reference thereto, in a preferred embodiment, a protocol of the type disclosed herein is implemented by the RF client 301 as a hyper distribution communications protocol 303 among the RF nodes, one in which the client 301 maintains a decentralized and distributed database 305 of transactions between the RF nodes. In an especially preferred embodiment, the protocol 305 is based on the principles of blockchain and bit torrent. Both concepts have commercial and open source packages, some of which are incorporated into products, and some of which are standalone. The RF client 301 is further equipped with agent 307 and server 309 modules with associated functionalities, and is adapted to provide output in application 311 or data 313 format.

Bit torrent is a mesh or peer-to-peer networking technology. Of any three nodes that communicate with each other, none of the parties is required to be the server. Rather, all three nodes may have a piece of the data in parity, and may act in concert to form copies. If one of the nodes dies out, the other two will finish the replication themselves. If there is an update to be implemented, the update gets pushed out en masse until all of the nodes have it.

Bit torrent is currently used to accelerate downloads. The bit torrent protocol also allows a user to throttle or to metricize one download, stream, file or load higher than another. Prioritization may be set based on trust so that if the same file is available from multiple sources, the download will occur from the most trusted source. Bit torrent also maintains a list of its peers, and can track up or down and speed.

The combination of blockchain and bit torrent in the systems and methodologies described herein provides a powerful, secure, scalable, non-repudiated, encrypted means of communication. However, the two are separate programs. In particular, one of these programs occurs at the software or application level and has nothing to do with transit, and the other occurs at the transit or network level. Since there are no linkages between them, it may be necessary to create software (or in some embodiments, hardware) that takes input and manipulates it in the network infrastructure (a la bit torrent). This software may also be equipped with an agent and a server (not the same as those of the collector). The collector may merely act as a dumb device to terminate one connection, normalize it and send it out.

The protocols disclosed herein may (but are not required to) be used in conjunction with a plurality of collectors, wherein the protocol specifies the manner in which the collectors work with each other. In such a configuration, the agent may be adapted to listen (a la bit torrent) for communication.

The foregoing principles may be further understood by considering the use case of RFID devices having limited battery life. If 20 of these devices are disposed inside of a carton, one of the devices can be nominated the master device, and can take a peer-to-peer range of the other 19 devices. After this, the master device may power down the antennae of the remaining devices, and each of the remaining devices can cease any further communications as long as their states have not changed. When the container is excited, the manifest file of a blockchain may be utilized to get the details of the 19 other devices by having the master device communicate with them. This approach conserves battery life, and increases the ability of the RFID devices. Using the concept of bit torrent, once the master device has been removed from the group (because it has been sold or has otherwise left the collective), the remaining devices can do a peer check and promote a new master, whose antenna can then be activated.

Extending the foregoing example to the aforementioned use case of a set of light posts near a stadium, suppose two of the light posts are not working. The other light posts will know that those light posts are offline, and will reroute traffic accordingly, because they note the gap in the light post sequence. As soon as the down light posts come back online, the communication vehicle may be reformed, taking the shortest path.

FIG. 3 is a block diagram of the software architecture of an embodiment of a system for implementing a hyper distribution communications protocol and distributed transaction database in accordance with the teachings herein. The system 301 depicted therein comprises a mobile ad-hoc mesh network 323 of the type described in FIGS. 1 and 2, which features a plurality of RF nodes. The RF nodes include a plurality of RF collectors, each having an instance of a distributed database 313 running thereon.

The system 301 includes an operating system 321 (here, an open source Linux operating system) which runs on the embedded platform. A layer 319 is disposed between the operating system 321 and the distributed database 313 which includes a decentralized routing protocol 317 and a virtual network 315. This protocol is preferably the B.A.T.M.A.N. (better approach to mobile ad-hoc networking) routing protocol for multi-hop ad-hoc mesh networks, which is described in detail at https://www.open-mesh.ori/projects/open-mesh/wiki. This protocol operates between network layers 2 and 3 and provides a virtual network 315 over which the distributed database 313 gains access to RF node data. Layer 319 implements a routing protocol utilized by network nodes for texting neighboring nodes. This approach may be utilized in the systems described herein to detect network nodes and the network as a whole.

The decentralized routing protocol 317 utilizes media access control (MAC) addresses to create a table of all of the RF nodes in the network, as well as all of the RF collectors. The resulting data represents the virtual network 315. Hence, network layers 2 and 3 provide virtual network 315 based on MAC addresses. Within this virtual network 315, all of the information about all of the RF nodes and their neighbors (including when they were last seen by an RF collector) is made available in real-time to all of the other RF collectors within the mesh network. Consequently, all of this information is available in real-time to all of the network nodes that are connected to the virtual network 315 in any way.

The system 301 depicted in FIG. 3 is equipped with RF software handlers 307 which are running on all of the RF collectors, and which provide a generic interface between the clients and server (via software drivers 309) and the application layer 303. Consequently, if a customer wishes to write an application to access, for example, Bluetooth or WIFI data, they can do so by accessing the generic interface provided by the RF software handlers 307.

As an example of the foregoing, consider a shipping company that wants to do something with the data that is being received from an RF collector and transmitted to all of the network nodes. The generic interface provided by the RF software handlers 307 allows the company to do whatever it wants to do with the data. Hence, the company can analyze the data, it can call a new function to send out new data, it can communicate to an external server or machine, it can provide the received data to a user via a new interface, or it can perform various other tasks utilizing the generic interface provided by the RF software handlers 307.

The system 301 depicted in FIG. 3 is also equipped with user applications 303. The user applications 303 only have an interface to the RF software handlers 307. The RF software handlers 307, in turn, only have a generic interface to the software drivers 309, the user applications 303 and the dashboard 305. The RF software handlers 307 provide a graphical user interface (GUI) to make data visible, and may be either clients or servers.

The software drivers 309 serve to repeat external data. They run on the RF collectors, and perform certain actions on the data collected. A server provides an interface to, or framework for, an external application which could be, for example, an application running on a mobile technology platform such as an Apple iPhone. In such an embodiment, the application on the mobile technology platform is connected to a software driver server application running on an RF collector. The server application may, for example, repeat control and status information from the mobile technology platform and perform some action on it. The server application may also communicate to other RF collectors or technology platforms.

The software driver layer 309 may be configured to transmit, encrypt and decrypt data. It thus provides a security level where the data may be secured. The foregoing role is important, since not all of the network nodes within the mesh network may be authorized to detect or read data from all other nodes. Hence, the software driver layer 309 may encrypt data from one RF collector and send it out to only a specific subset of the RF collectors in the network, including only a specific one of the other RF collectors in the network.

By way of example, the software driver layer 309 may encrypt the data such that all network nodes having a public key can decrypt and read the data. Groups of RF collectors can be created within the mesh network who can communicate with each other without interruption, and their communications may be protected and isolated from the rest of the network nodes. This approach can be utilized to create situations where data can only be modified through specific channels (for example, channels comprising network nodes that are equipped with a proper key).

The systems, methodologies and devices described herein may be utilized to implement time synchronization mechanisms (such as, for example, the precision time protocol (PTP) defined by the IEEE 1588 standard) on the RF collectors in the mesh network. Such time synchronization mechanisms may be utilized, for example, for the purposes of adding time stamps to data packages. This feature may be utilized, for example, to determine when data is received, or for data synchronization purposes.

By way of example, an RF collector of the type described herein may be paired with a machine equipped with multiple interfaces (such as, for example, a WIFI interface and a Bluetooth interface). The machine may then send out data by these multiple interfaces. While instances of the data may be related, they may not be time synced (for example, they may not have been sent out at the same time to the RF collector). In such cases, the time stamp may be utilized to resynchronize and reconstruct the original data. Since the RF collectors are preferably synchronized with each other in terms of the time protocol utilized, then, based on that protocol, the data may be synchronized with each other across the whole mesh network.

The time stamp may also be utilized to establish the state that goods were in when custody of the goods was transferred. For example, a cargo shipment may consist of 500 devices, each of which is equipped with an RFID tag. Half of the devices may be detectable by a first RF collector, and the other half may be detectable by a second RF collector. It may be desirable to establish whether all of the devices were included in one cargo at the time of shipment. Based on the time synchronization between the RF collectors, it may be determined that each of the RF devices detected 250 devices at the same time at the shipping location. This thus establishes that all 500 devices were shipped within the same cargo.

The dashboard 305 preferably runs on each of the RF collectors, preferably through the use of open-source software. The dashboard 305 may be utilized to provide real-time information to the user such as, for example, diagnostic and status information. Thus, for example, the dashboard 305 may be utilized to transmit control signals for the purpose of controlling the RF collector.

The software disclosed herein may be equipped with suitable functionality to provide real-time visualization and logging of the mesh network. For example, the software may be equipped with graphical and display features that provide a suitable visualization in which all of the network nodes are visible, and the manner in which they are connected to each other is indicated. Such a visualization may depict a list of all of the neighbors of a network node, and may indicate when each of these neighbors was last seen from the network node. Hence, the visualization may provide a real-time comprehensive overview of the mesh network—which nodes are connected to each other, which nodes are currently present in the network, which nodes are missing and, for those nodes that are missing, when they were last seen. Preferably, when a node joins the mesh network, it automatically appears on the dashboards associated with the RF collectors.

The dashboard may also indicate, in real-time, all of the connected RF sources within the mesh network. For example, if one of the RF collectors is equipped with a WIFI hotspot, the RF collector can automatically detect which network nodes are connected to it, and can read the names of those nodes. This information may be made available on a real-time basis to all of the other RF collectors. For example, if a first RF collector in the network detects a near field communication (NFC) text ID, that information may be placed in the logging table, and made available to other RF detectors in the mesh network.

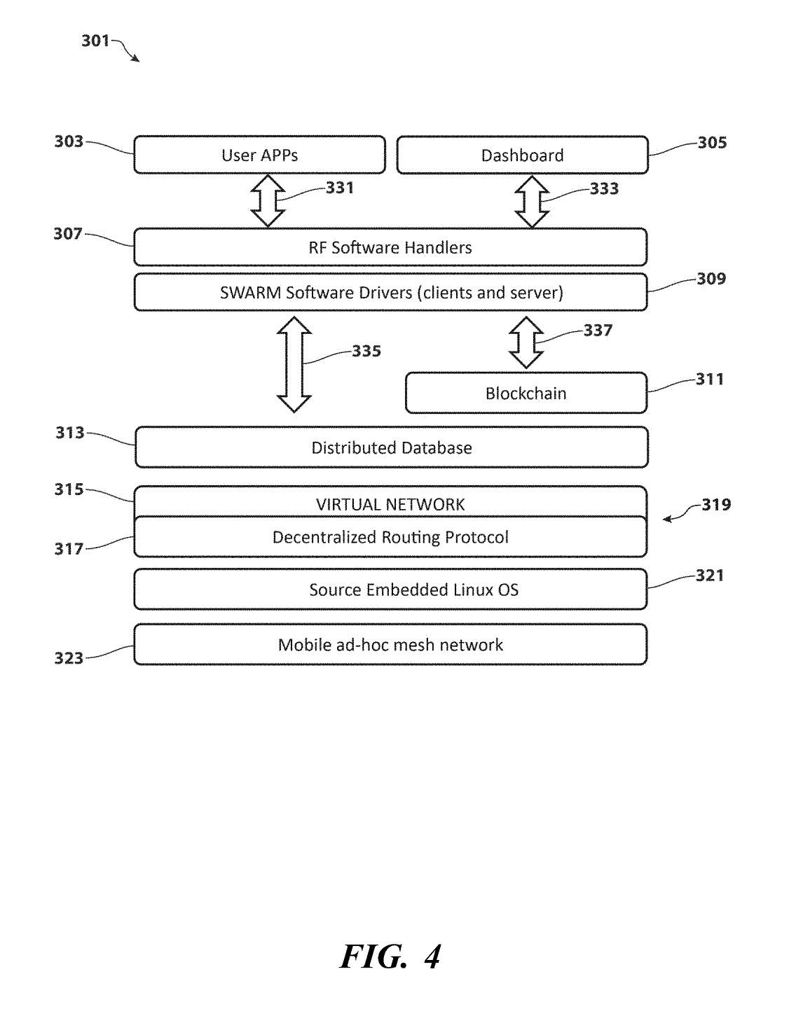

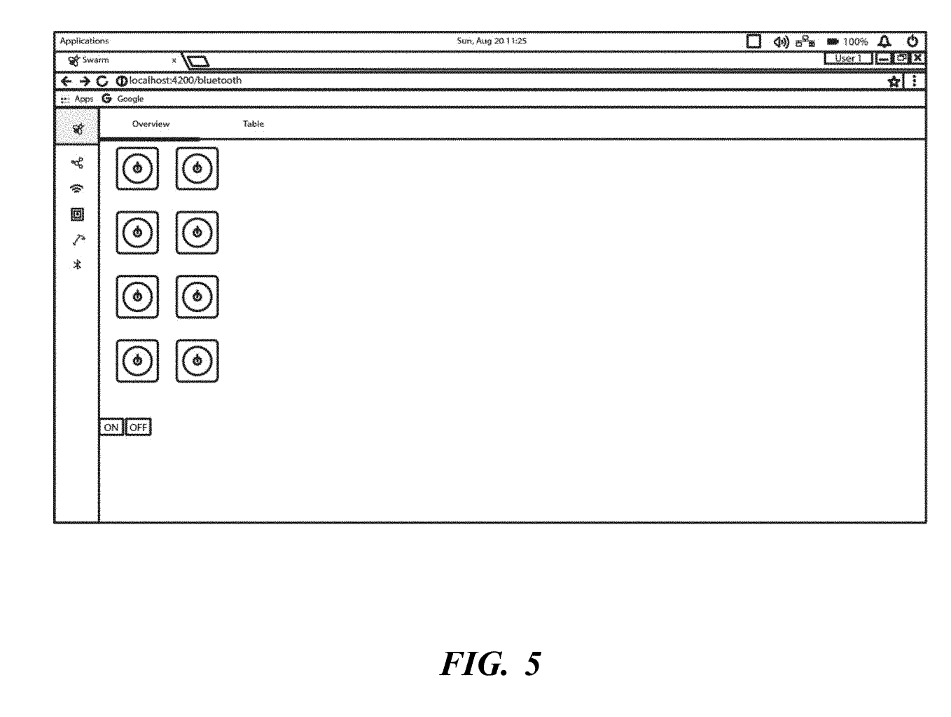

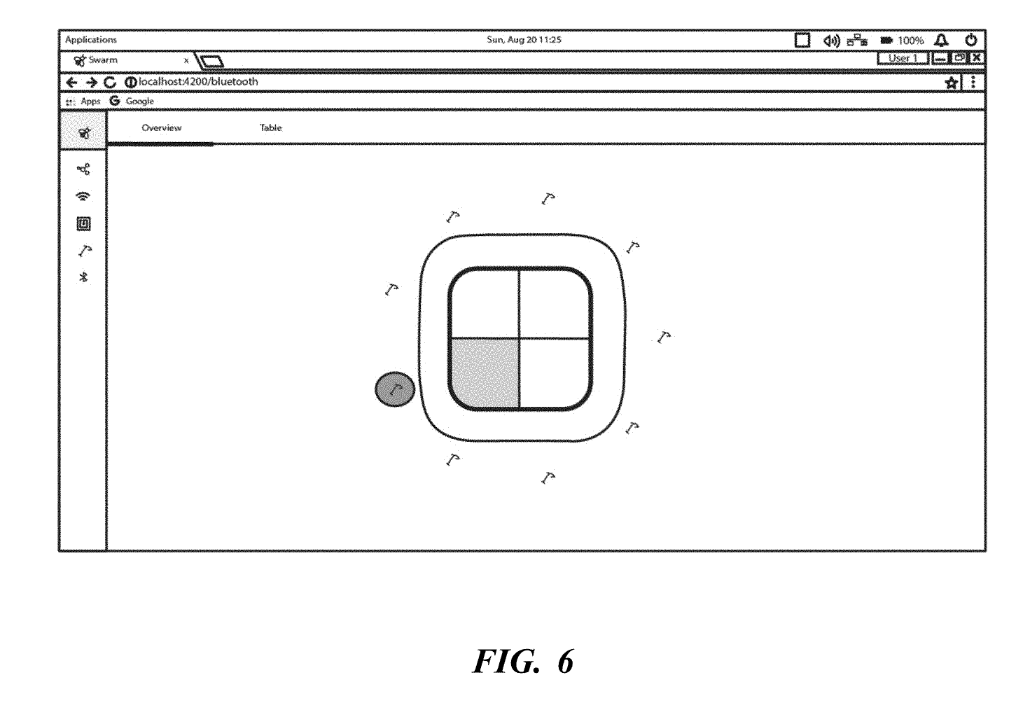

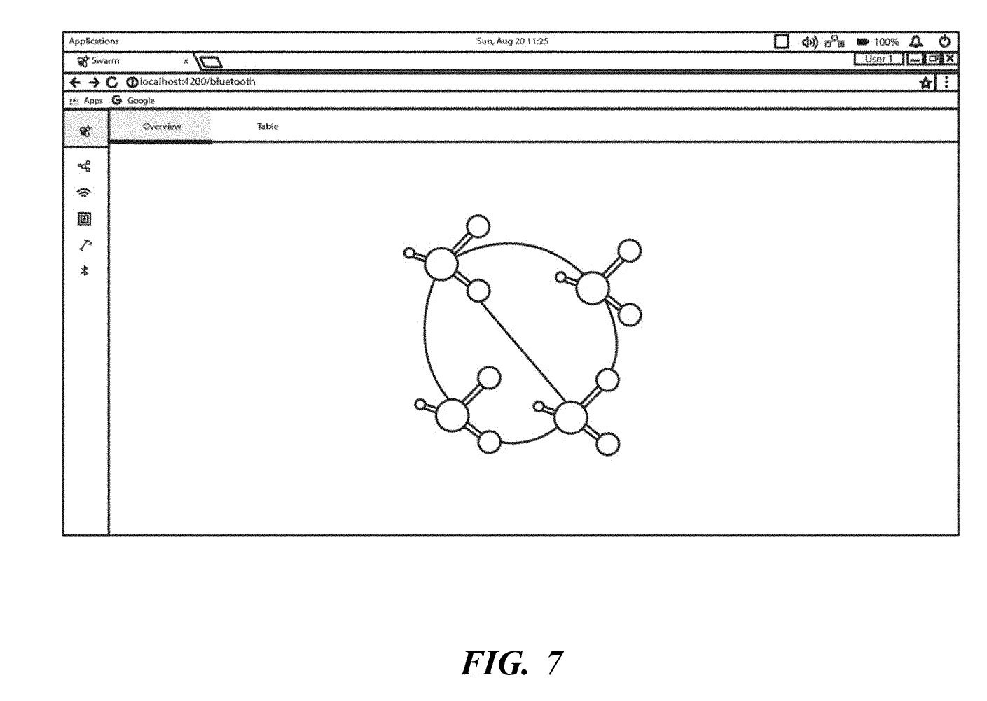

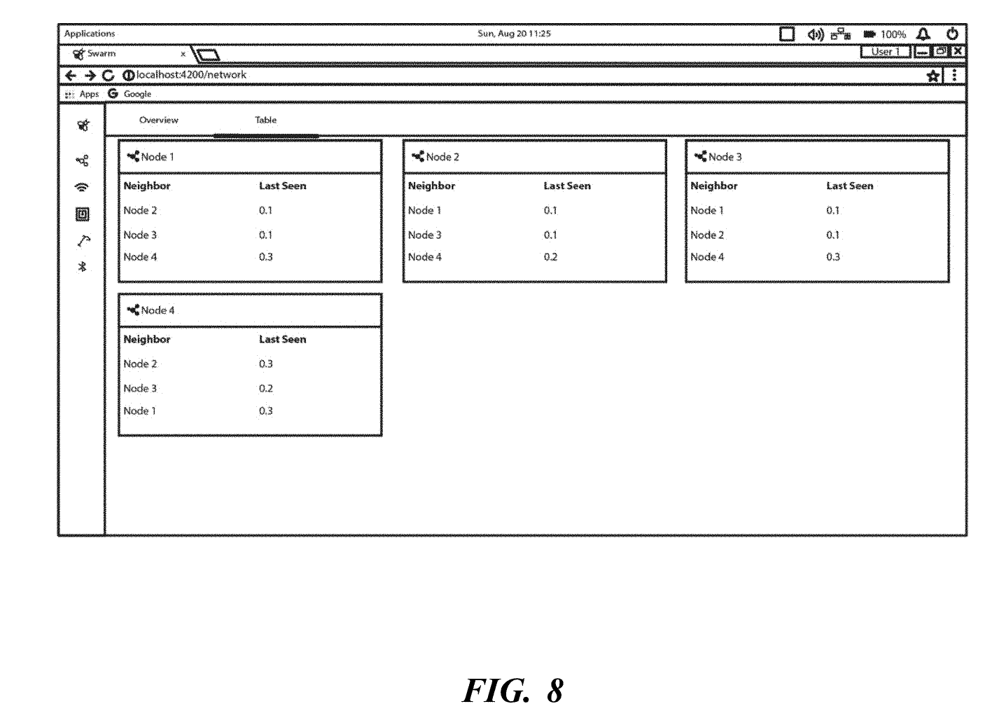

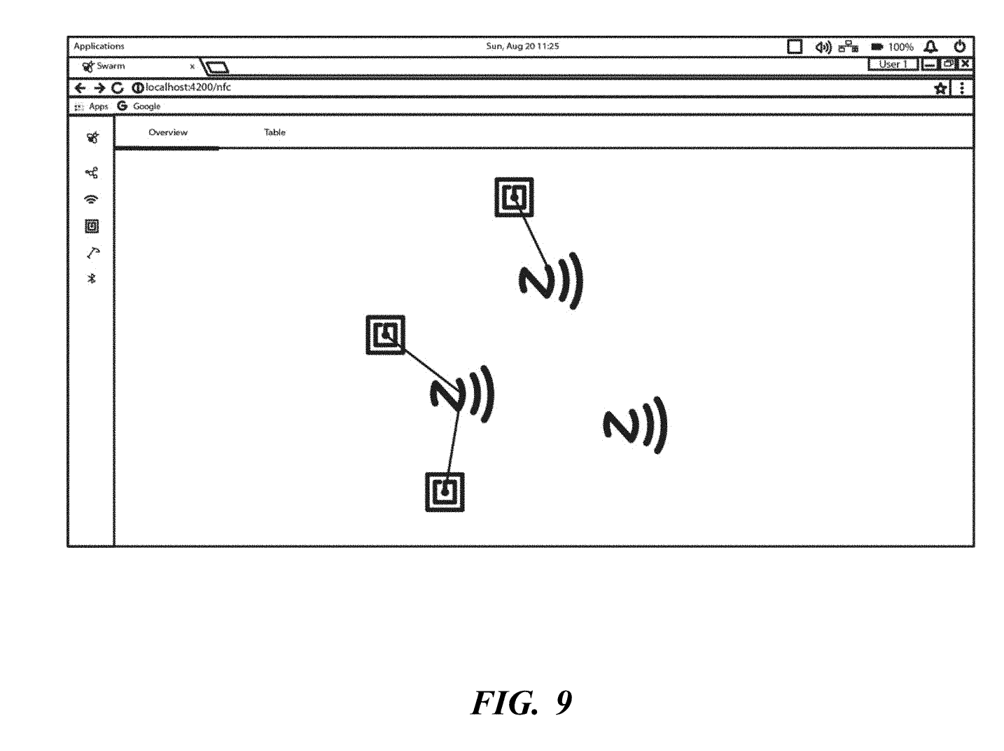

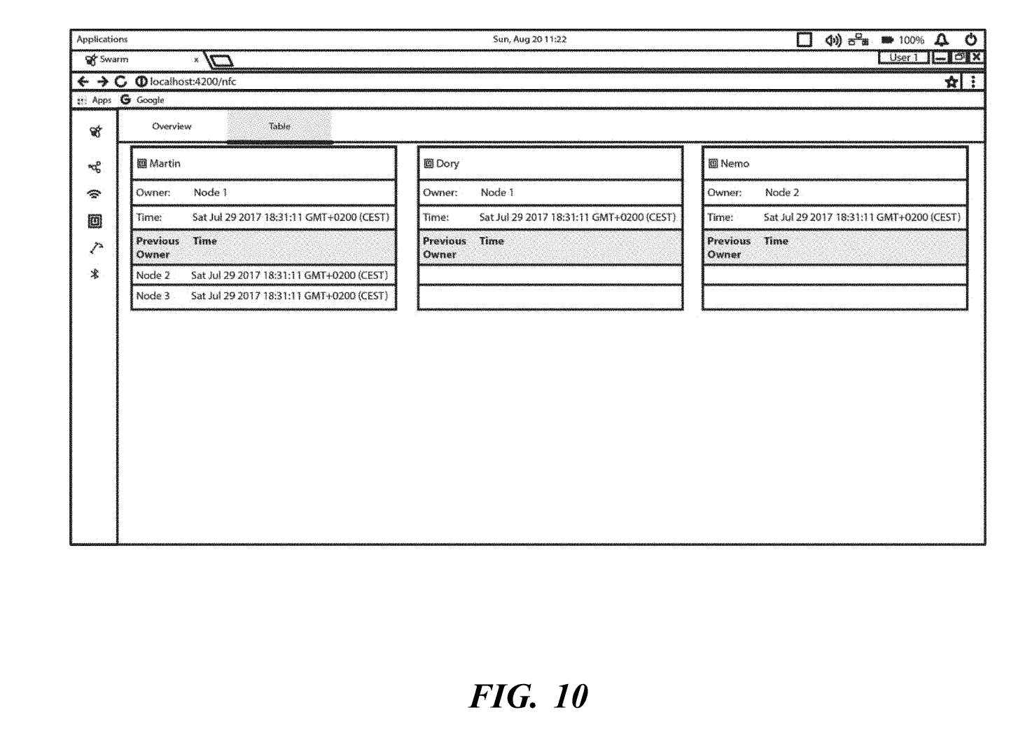

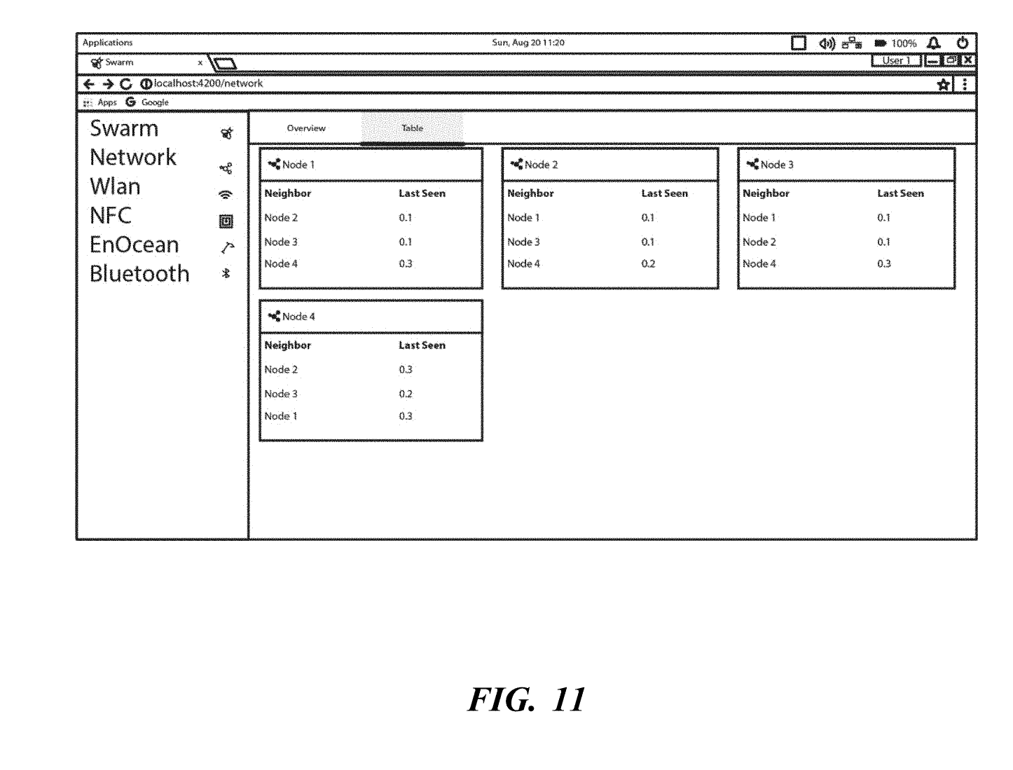

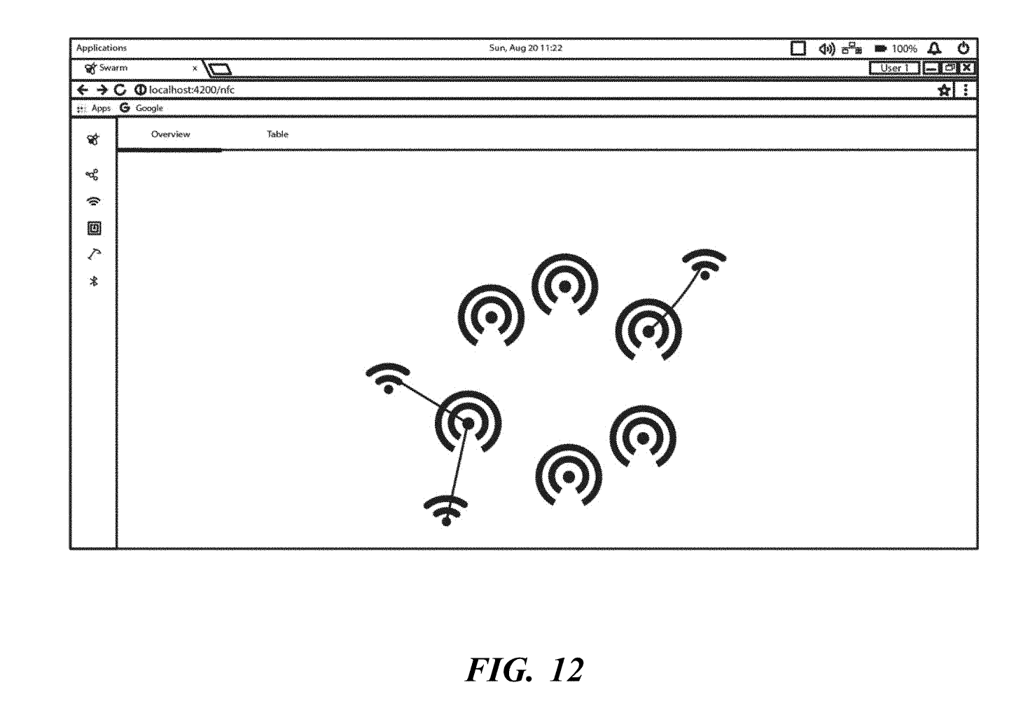

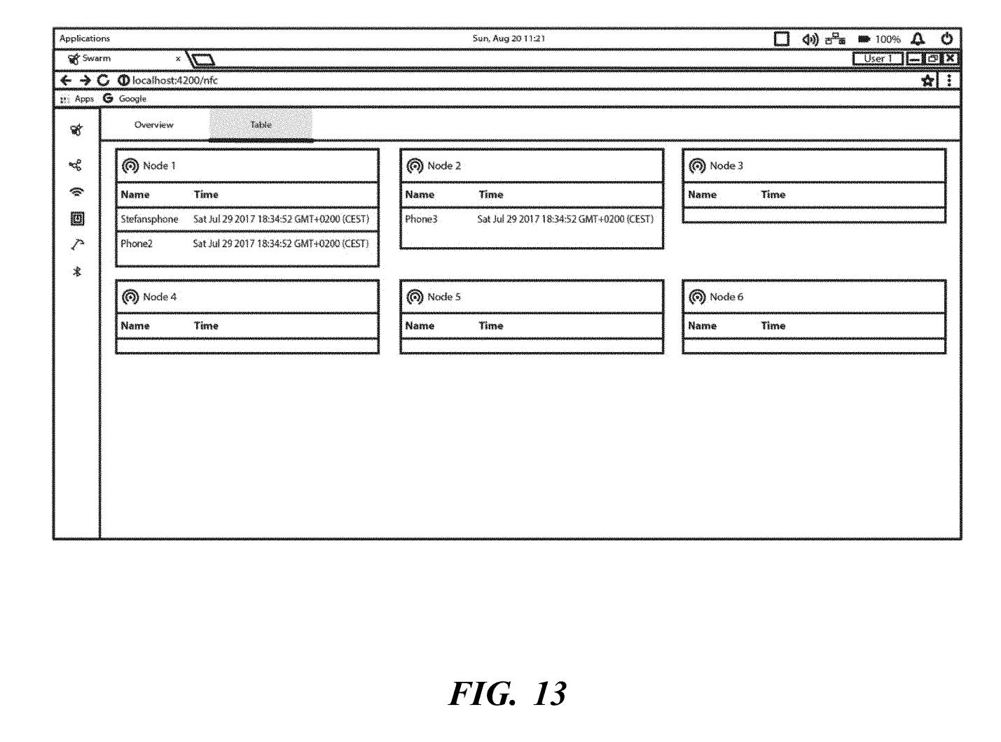

FIG. 4 is a block diagram of the software architecture of a particular, non-limiting embodiment of an ad hoc RF collector-based mesh network in accordance with the teachings herein. As seen therein, the architecture 401 features an application layer comprising user applications 403 and a dashboard 405. The architecture 401 further comprises software drivers 409, a blockchain module 411, a distributed database 413, a network layer 419 comprising a virtual network 415 and a decentralized routing protocol 417, a source embedded Linux operating system (OS) 421, and a mobile ad-hoc mesh network 423.

Specific to the instantiation of blockchain, blockchaining is being used, via the blockchain module 411, as a non-relational database and metadata source for encrypted information saved about the state of a connection. For example, when a first node in a network talks to a second node in the network, the first node will have information about the network interface, information about the time and specificity of the conversation, and metadata around the communication. These items form the header or description frames of the blockchain saved in the database.

In the example where the first node wants to tell the second node that variable x is the color purple, in the transitive message (e.g., the color purple) is the payload. In particular, purple is in the blockchain as an encrypted payload which is signed and encrypted by TKIP (temporal key integrity protocol) so that that the message that says “x=purple” may be replayed to another node in the event of failure, may be brought up from the database as a log entry for a forensic audit, and may be demonstrated in an investigation (e.g., in a criminal or hacking investigation) as an exact replay of the transaction (one that cannot be repudiated, forged or altered). These are three purposes of the use of the metadata and the encrypted payload data in the blockchain.

The blockchain 411 and the distributed database 413 work in conjunction with the network layer 419, the source embedded Linux OS 421 and the mobile ad-hoc mesh network 423 so that, in the metadata of the blockchain 411, if there is a conversation between node 1 and node 2 and all of the IP information, network transit, signal pipes, etc. in the metadata is saved, if node 2 fails, node 1 will receive a communication via bit torrent indicating that node 2 is no longer visible or available. It will then go into the database, retrieve all of the information it had about its conversation with node 2, and query other nodes (this query may essentially be of the form, “I was in the middle of a conversation with node 2. Here is the query of the metadata of the conversation, here is a playback of the payload, do you know anything about node 2?”). If another node (say node 3) is a replacement for a failed node 2, then it will replay all of the transactions recorded between node 1 and node 2 by the blockchain date element. If the payload was temporal, then the conversation between the nodes will be recorded, but cannot be replayed. Rather, only the description of the content can be retrieved.

Bit torrent is a peer-to-peer mesh networking protocol. It is used herein as a driver layer, and is implemented by the software drivers 409 and the network layer 419. A device driver is present in the source embedded operating system 421, and a routing protocol 417 is present in the TCP/IP stack. These software elements operate together to maintain a state in the routing and the arc table of the device of all of the peers of all of the mesh of all of the nodes that a given node is aware of.

There are some mechanisms that it does this and it is not relevant that it is bit torrent. For example, layer 2 protocol establishes a peer adjacency, which is a list of every other node that a given node knows about. In bit torrent, there are other fields added to the layer 2 and layer 3 information. These include not just the presence of a node but its link state (the connection to that node is alive or dead), activity (e.g., the node is currently being communicated with or is not), and a weight or performance metric (e.g., the speed of different paths or means of communication). These are integrated into preferred embodiments of the systems disclosed herein so that the blockchain database can query the bit torrent state table (this is maintained in memory of the network driver). The data may then be taken out of the bit torrent state and applied to the blockchain metadata database elements to allow the network connection to be reconstituted by favoring network parameters.

For example, consider the communication path between three nodes (node 1, node 2 and node 3). If node 1 is communicating with node 3 via node 2, but a direct pathway for communication between nodes 1 and 3 is found, then the direct pathway may be the fastest pathway for communication between node 1 and node 3. Information of this type is not maintained in blockchain, since blockchain is ignorant of any network transport protocol. Rather, blockchain is simply data storage encrypted with payload. It can have any type of data, and is ignorant as to what the data is being used for. By using blockchain for network state information, the network link state and the previous conversation element of the blockchain may now be used to reestablish a connection along a preferred route (e.g., directly between node 1 and node 3). The relationships between node 1 and node 2 can then be re-explained as metadata and payload within the blockchain. Similarly, the second relationship between node 1 and node 3 can also be explained as metadata and payload within the blockchain. Hence, both repositories may be maintained in real time.

In preferred embodiments of the systems and methodologies described herein, bit torrent also provides a state of the current conversation between nodes. In its conventional use, blockchain has no knowledge about the state of a network (e.g., if a network wire or RF signal is down). Rather, in conventional applications, blockchain functions simply a data element. Thus, for example, blockchain does not know if the connection between node 1 and node 2 has died. However, in the systems and methodologies described herein, bit torrent sends information through custom drivers (denoted in FIG. 4 as SWARM software drivers 409) to continuously poll (at a configurable time interval) the bit torrent log to determine whether any changes have occurred. If a change occurs (e.g., the connection between node 1 and node 2 is no longer working), a determination can be made as to whether any other communication routes exist between the nodes. If so, networking capabilities will be re-established in an encrypted, secure manner, with metadata and payload, by obtaining that real-time information through the bit torrent routing process.

It will thus be appreciated from the foregoing that preferred embodiments of the systems and methodologies described herein use blockchain and bit torrent in combination to provide a self-healing network. In preferred embodiments of these systems and methodologies, a node is not merely keeping track of the status of connections with other nodes, but is also continuously looking for better (e.g., faster, safer, or other metrics, depending on configuration) communications paths between itself and other nodes. Hence, these systems and methodologies utilize blockchain for a different purpose than its conventional use in cryptocurrency and cryptographically important data (such as health records, insurance records and military records). Blockchain has heretofore not typically been used for network communications and the status of network elements.

It will be appreciated from the foregoing that the systems, methodologies and devices disclosed herein, and the mesh networks that may be created with them, may have various useful features and functionalities, some of which have been expounded upon above. These include, without limitation, one or more of the following features and functionalities:
(a) The use of an open-source, decentralized routing protocol for multi-hop mobile ad hoc mesh networks running on RF Collectors. The routing protocol allows RF collectors or nodes to have knowledge about the best route through the network, even in implementations in which no single node has all the data.
(b) The use of an open-source routing protocol within a mesh network running on RF Collectors to provide a virtual network interface and transparently transports packets on its own.
(c) The use of an open-source routing protocol within a mesh network running on RF Collectors which resides between network layer 2 and 3, and which provides a virtual network interface based on MAC Addresses in real-time.
(d) A software implemented RF handler which is running on each individual RF Collector to provide an interface between different RF clients or servers and the application layer,
(e) The use of software drivers (RF client or server) to encrypt and decrypt RF data received or transmitted by an RF collector in real-time.
(f) The use of a time synchronization mechanism (e.g., IEEE 1588 (PTP)) on each RF collector for adding timestamps to data packages.
(g) The use of a dashboard on a RF collector to provide information to the user in real-time.
(h) The implementation of a decentralized database using a virtual network on a mesh network of RF collectors.
(i) The writing of RF data, either in a database directly or by using a blockchain running on RF collectors in a mesh network, and the real-time decision to write into the blockchain or directly into the database.
(j) The realization of isolated mesh networks based on RF collectors (mesh RF secured group). An RF secured group may communicate with others by using secure data transfers.
(k) The use of an open-source dashboard on each RF collector to interact with the user and to provide status and diagnostic information of the mesh network in real-time.
(l) The use of a dashboard to provide real-time visualization and logging of the mesh network at each of the RF collectors within the mesh network.
(m) The use of a dashboard to provide real-time visualization and logging of connected RF sources at each of the RF collectors within the mesh network.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Unless otherwise indicated, the use herein of the conjunctive “or” shall be construed inclusively. Thus, for example, the phrase “A or B” shall be construed to include only A, only B, and A and B.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-18. (canceled)

19. A method for establishing a communications network among a plurality of radio nodes, the method comprising:
organizing the plurality of radio nodes into a network in which each of said radio nodes are in RF communication with each other, wherein said plurality of radio nodes includes first and second radio nodes that communicate via first and second distinct RF protocols or RF technologies;
aggregating the spectrum of RF communications from the plurality of radio nodes; and
normalizing the aggregated RF communications into a singular output format.

20. The method of claim 19, wherein said plurality of radio nodes includes a plurality of RF-enabled devices.

21. The method of claim 19, wherein said plurality of radio nodes are organized in a mesh topology.

22. The method of claim 21, wherein said wireless mesh topology utilizes shortest path bridging.

23. The method of claim 19, wherein the RF collector comprises a plurality of RF antennas.

24. The method of claim 19, wherein said network is a fully connected network.

25. The method of claim 19, wherein said output format is use case dependent.

26. The method of claim 19, wherein said RF communications include RF communications employing a wireless communications protocol for home automation.

27. The method of claim 19, wherein said RF communications include RF communications employing the low-latency transmission of small data packets at data rates up to 100 kbit/s.

28. The method of claim 19, wherein said RF communications include RF communications employing a wireless communications protocol for the creation of personal area networks.

29. The method of claim 19, wherein said RF communications include RF communications employing a wireless communications protocol for the creation of wireless ad hoc networks.

30. The method of claim 19, wherein said RF communications include RF communications employing a wireless communications protocol based on an IEEE 802.15.4 specification.

31. The method of claim 19, wherein said RF communications include RF communications employing a wireless technology standard for exchanging data using short wavelength UHF radio waves in the ISM band from 2.4 to 2.485 GHz.

32. The method of claim 19, wherein said RF communications include RF communications which utilize electromagnetic fields to automatically identify and track RFID tags attached to objects, wherein said RFID tags contain electronically stored information.

33. The method of claim 19, wherein said RFID tags are selected from the group consisting of passive tags which collect energy from interrogating radio waves of a proximal RFID reader, and active tags which are equipped with a local power source.

34. The method of claim 19, wherein said RF communications include RF communications which utilize a set of media access control (MAC) and physical layer (PHY) specifications for implementing wireless local area network (WLAN) communications.

35. The method of claim 19, wherein said RF communications are in the 900 MHz and 2.4, 3.6, 5, and 60 GHz frequency bands.

36. The method of claim 19, wherein said RF communications include RF communications selected from the group consisting of Bluetooth, RFID, 802.11, Zigbee and Z-wave.

37-116. (canceled)
